(19) United States
(12) Patent Application Publication
(10) Pub. No.: US 2008/0199753 A1
(43) Pub. Date: Aug. 21, 2008

(54) Fluorine Treatment of Polyelectrolyte Membranes

(75) Inventors: Timothy J. Fuller, Pittsford, NY (US); Michael R. Schoeneweiss, West Henrietta, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/676,449

(22) Filed: Feb. 19, 2007

(51) Int. Cl. H01M 8/10

(52) U.S. Cl. 429/33

(57) ABSTRACT

A method for providing a polymer electrolyte membrane for a fuel cell that includes treating a hydrocarbon polymer membrane with fluorine to increase its acidity and acid content. Fluorine gas is mixed with an inert gas to dilute the fluorine so that it does not burn the hydrocarbon membrane. The mixed gas is introduced into a container in which the hydrocarbon membrane is mounted so that fluorine is deposited on the membrane. The gas is introduced into the container at a slow enough rate so that the fluorine does not burn the membrane.

### BACKGROUND OF THE INVENTION

1. Field of the Invention

This invention relates generally to a polymer electrolyte membrane for a fuel cell and, more particularly, to a method for treating a hydrocarbon electrolyte membrane with fluorine to improve its proton-conductivity by increasing its acidity to make the membrane more like a perfluorosulfonic acid membrane.

2. Discussion of the Related Art

Hydrogen is a very attractive fuel because it is clean and can be used to efficiently produce electricity in a fuel cell. A hydrogen fuel cell is an electrochemical device that includes an anode and a cathode with a polyelectrolyte therebetween. The anode receives hydrogen gas and the cathode receives oxygen or air. The hydrogen gas is dissociated at the anode to generate free protons and electrons. The protons pass through the electrolyte to the cathode. The protons react with the oxygen and the electrons at the cathode to generate water. The electrons from the anode cannot pass through the electrolyte, and thus are directed through a load circuit to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several hundred fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack.

PEM fuel cell performance is related to the proton conductivity of the polymer electrolyte membrane, which improves at higher humidification levels. However, PEMs with high proton conductivity at low relative humidity are important for automotive fuel cell systems because they typically require lower humidification levels to prevent parasitic power drains of the energy produced by various devices in the system, such as compressors and humidifiers. Perfluorosulfonic acid membranes are super-acid membranes that make good electrolyte membranes for PEM fuel cells because they maintain their high acidic level at low relative humidity, i.e., the membrane is able to effectively ionize at low water content. DuPont's Nafion 112, a perfluorosulfonic acid membrane, has a proton conductivity of about 0.035 S/cm at 50% relative humidity and 80° C., which provides the desired performance. However, perfluorosulfonic acid membranes, such as Nafion 112, are very expensive.

Various hydrocarbon polymer membranes, also suitable for fuel cell applications, are less expensive than perfluorosulfonic acid membranes. However, most hydrocarbon polymer membranes have a proton conductivity that is about a magnitude lower than that of Nafion 112 under the same humidity conditions at below 50% relative humidity. One explanation for the low conductivity of hydrocarbon membranes is that the functional proton-conducting group in the membrane is typically an aromatic-sulfonic acid group rather than a super-acid, perfluorosulfonic acid group. It would be desirable to attach perfluorosulfonic acid groups to hydrocarbon membranes to establish if sulfonic acid group acidity is driving the proton conductivity at low relative humidity. Unfortunately, the attachment of perfluorosulfonic acid groups to hydrocarbon polymers is not synthetically straightforward.

It would be desirable to increase the acidity and acid content of hydrocarbon membranes, such as aromatic-sulfonic acid hydrocarbon membranes and straight chain hydrocarbon electrolyte membranes, such as aliphatic membranes, to levels similar to perfluorosulfonic acid membranes to reduce fuel cell membrane cost.

### SUMMARY OF THE INVENTION

In accordance with the teachings of the present invention, a method for providing a polymer electrolyte membrane for a fuel cell is disclosed that includes treating a hydrocarbon polymer membrane with fluorine to increase its acid content and create a partially fluorinated or a perfluorinated hydrocarbon membrane. Fluorine gas is mixed with an inert gas to dilute the fluorine so that it does not burn the hydrocarbon membrane. The mixed gas is introduced into a container in which the hydrocarbon membrane is mounted so that fluorine is exposed to or brought in contact with the membrane. The gas is introduced into the container at a slow enough rate so that the fluorine does not burn the membrane.

Additional features of the present invention will become apparent from the following description and appended claims, taken in conjunction with the accompanying drawings.

### BRIEF DESCRIPTION OF THE DRAWINGS

FIG. 1 is a cross-sectional view of a fuel cell including a polymer electrolyte membrane; and

FIG. 2 is a block diagram of a system for exposing fluorine to a hydrocarbon membrane to provide a polymer electrolyte membrane having a high acid content, according to an embodiment of the present invention.

### DETAILED DESCRIPTION OF THE EMBODIMENTS

The following discussion of the embodiments of the invention directed to a system and method for depositing fluorine on a hydrocarbon membrane to provide a highly acidic polymer electrolyte membrane for a fuel cell is merely exemplary in nature, and is in no way intended to limit the invention or its applications or uses.

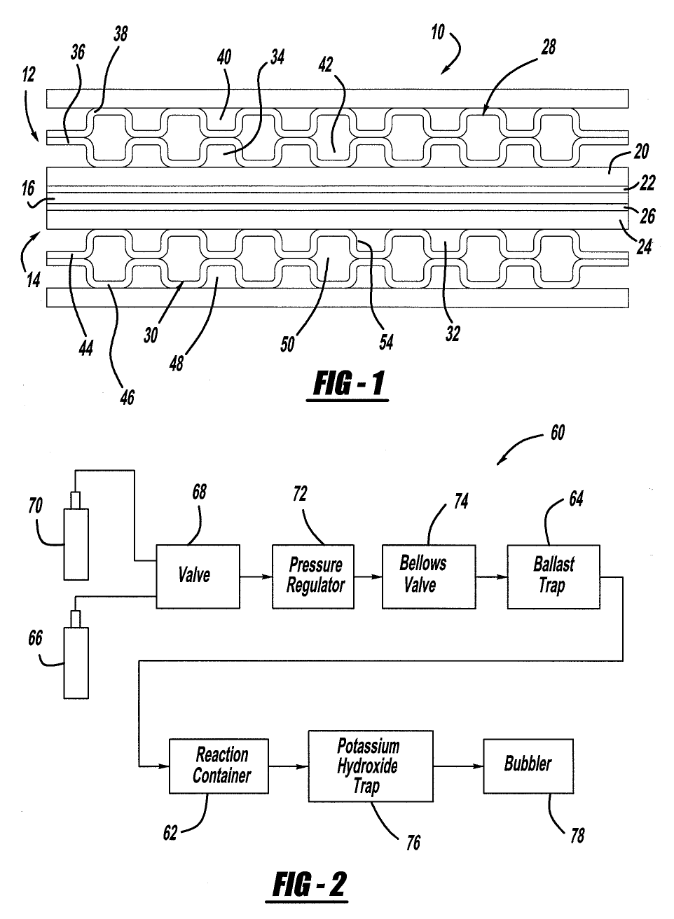

FIG. 1 is a cross-sectional view of a fuel cell 10 that is part of a fuel cell stack of the type discussed above. The fuel cell 10 includes a cathode side 12 and an anode side 14 separated by a polymer electrolyte membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 28 is provided on the cathode side 12 and an anode side flow field plate or bipolar plate 30 is provided on the anode side 14. The bipolar plates 28 and 30 are provided between the fuel cells in the fuel cell stack. A hydrogen reactant gas flow from flow channels 32 in the bipolar plate 30 reacts with the catalyst layer 26 to dissociate the hydrogen ions and the electrons. Airflow from flow channels 34 in the bipolar plate 28 reacts with the catalyst layer 22. The hydrogen ions are able to propagate through the membrane 16 where they carry the ionic current through the membrane 16. The end product is water, which does not have any negative impact on the environment.

In this non-limiting embodiment, the bipolar plate 28 includes two stamped metal sheets 36 and 38 that are welded together. The sheet 36 defines the flow channels 34 and the sheet 38 defines flow channels 40 for the anode side of an adjacent fuel cell to the fuel cell 10. Cooling fluid flow channels 42 are provided between the sheets 36 and 38, as shown. Likewise, the bipolar plate 30 includes a sheet 44 defining the flow channels 32, and a sheet 46 defining flow channels 48 for the cathode side of an adjacent fuel cell. Cooling fluid flow channels 50 are provided between the sheets 44 and 46, as shown. The bipolar plates 28 and 30 can be made of any suitable conductive material that can be stamped, such as stainless steel, titanium, aluminum, etc.

The present invention proposes a technique for converting a hydrocarbon polymer membrane, such as an aromatic-sulfonic hydrocarbon membrane or a straight chain hydrocarbon membrane, into a partly fluorinated or a perfluorinated super-acidic polymer electrolyte membrane suitable for use in a fuel cell. One direct approach towards making perfluorinated sulfonic acid groups from non-fluorinated precursors is by the direct fluorination of hydrocarbon membranes using a fluorine gas diluted in an inert carrier gas. As will be discussed in detail below, a particular hydrocarbon membrane sample is positioned within a container, and a mixture of a fluorine gas and an inert gas, such as nitrogen, is introduced into the container for a certain period of time and a certain flow rate to deposit the fluorine on the membrane.

FIG. 2 is a block diagram of a system 60 for exposing fluorine to a hydrocarbon polymer membrane to make it more acidic and more suitable for a polymer electrolyte membrane for a fuel cell, especially at lower relative humidity levels. In one non-limiting embodiment, the membrane is about 25 μm thick. The membrane is positioned within a reaction container 62, such as a 60-mL perfluoroethylene-proplyene (FEP) impinger-vessel having a screw cap lid. In one embodiment, the membrane is first folded in alternating directions in rolls similar to a fluted filter paper fan in order to maximize membrane surface area and subsequent exposure to the fluorine gas, and then the folded membrane is inserted into the reaction container 62 and the screw cap is secured. A ballast trap container 64 is provided upstream from the reaction container 62 to prevent back-flow of reaction gases from the reaction container 62.

An inert gas, such as nitrogen, from a tank 66 is provided to a valve 68 and a fluorine gas from a tank 70 is provided to the valve 68 where they are mixed. The valve 68 controls the percentage of the nitrogen and the fluorine in the mixed gas and the flow rate of the mixed gas through the system 60. In one non-limiting embodiment, the amount of fluorine in the mixed gas is less than 20 weight percent and the flow rate of the mixed gas is about 50 to 70 bubbles per minute for a time of about one hour. The amount of fluorine in the mixed gas needs to be limited so that it does not burn the membrane. Also, the mixed gas needs to be introduced into the container 62 at a slow enough rate so that the fluorine does not burn the membrane.

The mixed gas passes through a two-stage, step-valve regulator 72 that reduces the tank pressure to a system pressure. The mixed gas is then sent through a Swagelok bellows valve 74 to maintain gas regulation and flow. The gas is then sent to the ballast trap container 64 that prevents backflow of the gas from the container 62. The mixed gas is then sent to the reaction container 62 where the reaction takes place and the fluorine is deposited on the membrane. The mixed gas is sent to the reaction container 62 for a long enough period of time so that a desirable amount of the fluorine is deposited on the membrane, and is able to be absorbed by the membrane to provide the desired acidity for fuel cell purposes.

From the reaction container 62, the gas then passes through a 500 mL Erlenmeyer flask trap 76 containing about 500 g of potassium hydroxide, and then through a 250 mL bubbler 78 containing a sodium sulfite solution. Should the sodium sulfite solution change from brown to black in color, the reaction should be shut down immediately by closing the gas cylinder valve. The sulfite solution serves as an indicator of fluorine that has not reacted with the membrane in the reaction container 62. At the end of the reaction time, the lines are purged with nitrogen.

In an alternate embodiment, the membrane is fluorinated by dipping the membrane in a fluorinated solvent, such as Freon.

Many suitable hydrocarbon polymer membranes are available that can be treated with fluorine to increase their acidity to a level commensurate with perfluorosulfonic acid membranes. Suitable samples include, but are not limited to:
Nafion in a perfluorosulfonyl fluoride form (DE-0838WX),
F₂-treated Nafion DE-0838 WX,
Nafion 112,
F₂-treated Nafion 112,
F₂-treated solution cast Nafion 1000,
F₂-treated poly[perfluorocyclobutane] (PFCB),
F₂-treated PFCB for 30 minutes,
F₂-treated PFCB for 1 hour at room temperature,
F₂-treated sulfonated poly[biphenyl-perfluorocyclobutane],
Parmax 1200, a polyphenylene from Mississippi Polymer Technology,
F₂-treated Parmax 1200,
Sulfonated Parmax 1200 with an ion exchange capacity between 1.0 and 3 milliequivalents of sulfonic acid per gram of resin,
F₂-treated Sulfonated Parmax 1200 for 30 minutes and 1 hour,
Polyarylene thioether,
A sulfonated polyarylene ether ketone, designated SV359-PD356a available from polyMaterials, AG, Kaufbeuren, Germany,
F₂-treated SV359-PD356a,
SV359-PD356b, a sulfonated polyarylene ether ketone available from polyMaterials, AG, Kaufbeuren, Germany,
BS46-PD3726-009, a sulfonated polyarylene thioether ketone available from polyMaterials, AG, Kaufbeuren, Germany,
Sulfonated polyarylene thioether sulfones,
Sulfonated poly(4-phenyl-1-butene), or other aliphatic-aromatic polymer, such as polystyrene, and
F₂-treated BS46-PD3726-009.

After the membrane is treated with the fluorine gas, the membrane can be characterized with an attenuated total reflectance Fourier transform infrared spectroscopy (ATR-FTIR). From this imaging, for all of the hydrocarbon membranes, the fluorine treatment appears to completely remove nearly all of the aromatic protons and keto-groups on the surface layers of the films. The mechanical properties of the membranes remained robust after fluorination. This was especially true of block polymers with disparate morphological domains, as evidenced by analysis with transmission electron microscopy.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing a polymer electrolyte membrane for a fuel cell, said method comprising:
providing a hydrocarbon membrane; and
depositing fluorine on the hydrocarbon membrane so as to increase its acid content.

2. The method according to claim 1 wherein providing a hydrocarbon membrane includes providing an aromatic-sulfonic acid membrane.

3. The method according to claim 1 wherein providing a hydrocarbon membrane includes providing a straight chain hydrocarbon membrane.

4. The method according to claim 3 wherein providing a straight chain hydrocarbon membrane includes providing an aliphatic sulfonic acid membrane.

5. The method according to claim 3 wherein providing a straight chain hydrocarbon membrane includes providing an aliphatic-aromatic sulfonic acid membrane.

6. The method according to claim 1 wherein depositing fluorine on the membrane includes depositing a fluorine gas combined with an inert gas on the membrane.

7. The method according to claim 6 wherein the percentage of fluorine in the gas is less than 20 weight percent.

8. The method according to claim 6 wherein the inert gas is nitrogen.

9. The method according to claim 6 wherein the gas is introduced into a container in which the hydrocarbon membrane is mounted at a slow enough rate so that the gas does not burn the membrane.

10. The method according to claim 6 wherein the concentration of fluorine in the combined gas is low enough so as to not burn the membrane.

11. The method according to claim 1 wherein depositing fluorine on the membrane includes depositing a fluorinated solvent on the membrane.

12. The method according to claim 11 wherein the fluorinated solvent is Freon.

13. The method according to claim 1 wherein providing a hydrocarbon membrane includes providing a sulfonated hydrocarbon membrane selected from the group consisting of perfluorocyclobutane, Parmax, polyarylene thioether ketone, polyarylene ether thiosulfone, poly(4-phenyl-1-butene) and polyarylene ether ketone membranes.

14. A method for providing a polymer electrolyte membrane for a fuel cell, said method comprising:
providing a hydrocarbon membrane in a reaction container;
providing a mixed gas including a fluorine gas and an inert gas; and
introducing the mixed gas into the reaction container so that the mixed gas is deposited on the membrane so as to increase the acid content of the membrane.

15. The method according to claim 14 wherein providing a hydrocarbon membrane includes providing an aromatic-sulfonic acid membrane.

16. The method according to claim 14 wherein providing a hydrocarbon membrane includes providing a straight chain hydrocarbon membrane.

17. The method according to claim 14 wherein the percentage of fluorine in the mixed gas is less than 20 weight percent.

18. The method according to claim 14 wherein the inert gas is nitrogen.

19. The method according to claim 14 wherein the concentration of fluorine in the mixed gas is low enough so as to not burn the membrane.

20. The method according to claim 14 wherein the mixed gas is introduced into the reaction container at a slow enough rate so that the mixed gas does not burn the membrane.

21. The method according to claim 14 wherein providing a hydrocarbon membrane includes providing a sulfonated hydrocarbon membrane selected from the group consisting of perfluorocyclobutane, Parmax, polyarylene thioether ketone, polyarylene ether thiosulfone, poly(4-phenyl-1-butene) and polyarylene ether ketone membranes.

22. A polymer electrolyte membrane for a fuel cell, said membrane comprising:
a hydrocarbon base layer; and
a fluorine layer deposited on the hydrocarbon base layer so as to increase its acid content.

23. The membrane according to claim 22 wherein the hydrocarbon base layer is selected from the group consisting of aromatic-sulfonic acid layers and straight chain hydrocarbon layers.
